(19) United States
(12) Patent Application Publication
(10) Pub. No.: US 2016/0019016 A1
(43) Pub. Date: Jan. 21, 2016

(54) AUGMENTED REALITY DOLL

(71) Applicant: STELLO GIRLS LTD., Tel Aviv (IL)

(72) Inventor: Maya KOCHAVI, New York, NY (US)

(73) Assignee: STELLO GIRLS LTD.

(21) Appl. No.: 14/799,626

(22) Filed: Jul. 15, 2015

Related U.S. Application Data
(60) Provisional application No. 62/025,251, filed on Jul. 16, 2014.

(51) Int. Cl. G06F 3/14; G02B 27/01; G10L 15/26; G06T 19/00

(52) U.S. Cl. CPC G06F 3/14; G06T 19/006; G02B 27/017; G10L 15/265; G02B 2027/0178

(57) ABSTRACT

A physical doll including active electronic data processing capabilities which provide supplementary visual effects to a user via a wireless connection to augmented reality glasses worn by the user. A virtual version of the doll is seen by the user superimposed over the user's current physical environment. The physical doll may be comparable in size to a typical doll, whereas the virtual version of the doll may have the visual appearance of a fully-grown person. The augmented reality features can be initiated by physically placing the doll onto a dock or by other means. The active electronic data processing capabilities can be included in the doll, the dock, both the doll and the dock, or distributed between the doll and the dock. The active electronic data processing capabilities can also include video game-playing and artificial intelligence, and the virtual version of the doll may play video games with the user.

### CROSS REFERENCE TO RELATED APPLICATIONS

This application claims benefit of U.S. Provisional Patent Application Ser. No. 62/025,251, filed Jul. 16, 2014, entitled “Augmented reality doll”, the disclosure of which is hereby incorporated by reference and the priority of which is hereby claimed pursuant to 37 CFR 1.78(a) (4) and (5)(i).

### BACKGROUND

Children enjoy having and playing with physical dolls and action figures, but they also enjoy imagining that these toys extend beyond the realm of inanimate objects. It would therefore be desirable to combine fantasy properties into a physical doll, such that the child can interact with the doll both through physical contact as well as virtual involvement in the same physical space as the doll. This goal is met by embodiments of the present invention.

### SUMMARY

Embodiments of the present invention provide augmented reality properties in a physical doll, such that a child can play with the doll both at the physical and virtual level, where the virtual properties of the doll are projected into the child's immediate physical surroundings.

The term “doll” herein denotes any figurine in a form, shape, design, or appearance to which a character or personality is fancifully attributed, including toys commonly referred to as “dolls” and “action figures”. Non-limiting examples of dolls include: humanoid or animal figurines; robotic figurines; figurines of mythological creatures, fictional creatures, creatures of fable and folklore, pets and mascots, and the like; figurines of anthropomorphized machinery and other artifacts; and figurines related to science fiction and fantasy genres of literature and other media, including characters created for advertising, marketing, and publicity, or similar commercial or institutional purposes.

The term “augmented reality” herein denotes a real-time direct or indirect view of the physical, real-world environment whose physical features are supplemented by computer-generated sensory-perceptible features including, but not limited to: images, both static and dynamic, including animations and video; graphics; and sound. The term “computer” herein denotes an electronic data processing system or apparatus, device, or active component thereof. Augmented reality is contrasted with “virtual reality” in that virtual reality replaces the perception of the physical environment with a computer-generated simulated environment, whereas augmented reality adds virtual features to the perception of the physical environment. The term “mediated reality” herein denotes a real-time usually indirect view of the physical, real-world environment whose physical features are altered by being supplemented, diminished, and/or transformed.

The term “augmented reality doll” herein denotes a physical doll which has been provided with an active electronic data device, through which augmented reality properties are attained in association with the physical doll. In an embodiment of the present invention, the active electronic data device is at least partially contained within the physical doll. In another embodiment of the present invention, the active electronic data device is at least partially contained within a dock onto which the physical doll can be placed. According to various embodiments of the present invention, the augmented reality properties include an image of a virtual version of the augmented reality doll. The term “virtual version” with reference to the virtual version of the augmented reality doll herein also denotes the image which is generated at least partially by the active electronic data device. In a related embodiment, the virtual version of the doll has an appearance that is transformed in some manner from that of the physical doll. In a further related embodiment, the virtual version of the doll has visual dimensions corresponding to those of a full-size person.

Therefore, according to an embodiment of the present invention, there is provided an augmented reality doll including: (a) a physical doll; (b) an active electronic data device including a data processor; (c) a non-transitory data and program storage unit; containing executable code for execution by the data processor; (d) a data communications interface; and (e) a data connection for connecting to augmented reality glasses; (f) wherein the active electronic data device, via the executable code executed by the data processor, is operative to connect via the data connection to the augmented reality glasses and to communicate data to the augmented reality glasses for display of a virtual version of the augmented reality doll.

### BRIEF DESCRIPTION OF THE DRAWINGS

The subject matter disclosed may best be understood by reference to the following detailed description when read with the accompanying drawings in which:

FIG. 1A illustrates the appearance of a physical augmented reality doll according to an embodiment of the present invention.

FIG. 1B is a conceptual block diagram of a data processing arrangement within the physical augmented reality doll of FIG. 1A according to various embodiments of the present invention.

FIG. 2A illustrates a dock, or pedestal for a physical augmented reality doll of FIG. 1A, according to an embodiment of the present invention.

FIG. 2B is a conceptual block diagram of a data processing arrangement within the dock of FIG. 2A according to various embodiments of the present invention.

FIG. 3A illustrates placing the physical augmented reality doll of FIG. 1A onto the dock of FIG. 2A.

FIG. 3B conceptually illustrates a virtual figure representing an alternative representation of the augmented reality doll as seen through augmented reality glasses, according to an embodiment of the present invention.

FIG. 4A illustrates a scene of a hypothetical video game being displayed on a television or computer screen, while at the same time featuring a view of a virtual version of the augmented reality doll according to an embodiment of the present invention.

FIG. 4B illustrates a scene of a hypothetical video game in augmented reality, and featuring a view of the augmented reality doll according to another embodiment of the present invention.

FIG. 5 conceptually illustrates a smartphone or tablet application for remote control of a physical augmented reality doll according to an embodiment of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

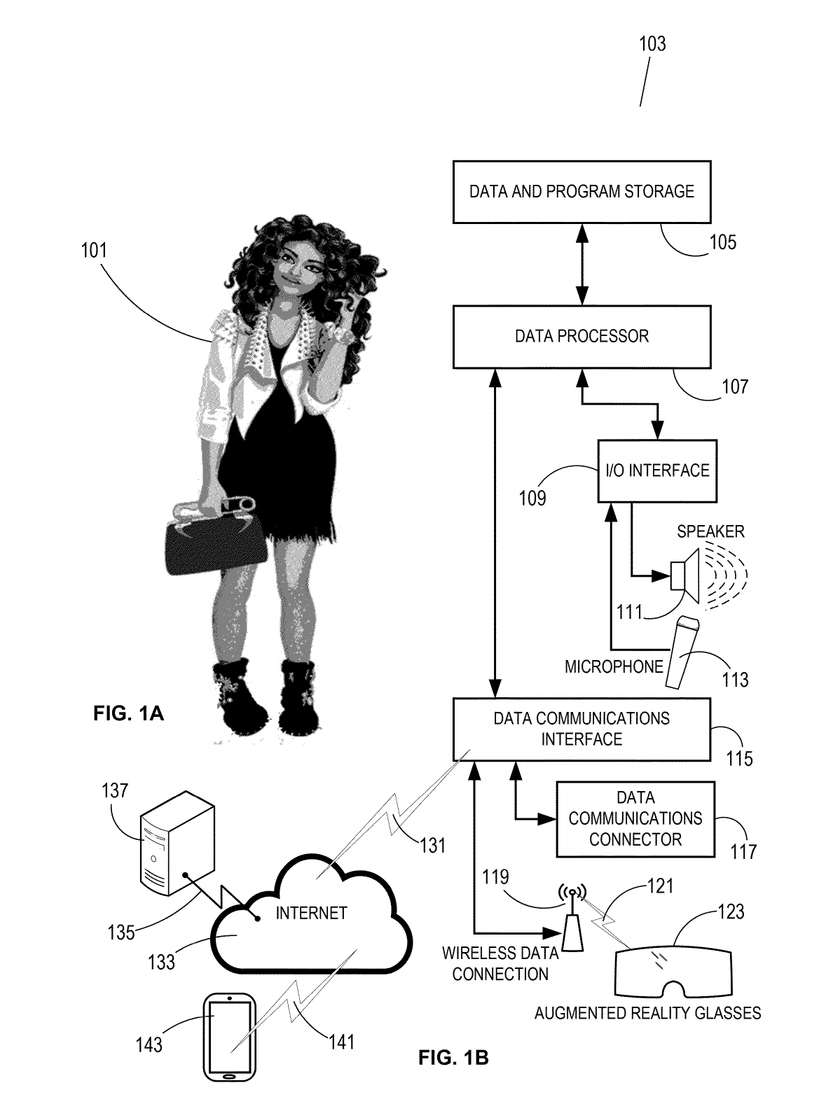

FIG. 1A illustrates the appearance of a physical augmented reality doll 101 according to an embodiment of the present invention. In this embodiment, physical augmented reality doll 101 is the size of a typical doll that a child would have. In other embodiments, physical augmented reality doll 101 is sized in height and weight according to the age, height, and weight of the child. It is noted that these size comparisons relate to the tangible physical doll, not the virtual reality image of the doll.

FIG. 1B is a conceptual block diagram of a data processing arrangement 103 within physical augmented reality doll 101 of FIG. 1A according to various embodiments of the present invention. A non-transitory data storage unit 105 stores data and program information for a data processor 107. A data communications interface 115 allows data processor 107 to communicate with other devices, such as via a data communications connector 117 (a non-limiting example of which is a USB connector). In a similar embodiment, data communications connector 117 also provides electrical power connections. In a related embodiment, a data connection 119 is a wireless data connection allowing wireless communications with other devices via a wireless link 121, such as communications with augmented reality glasses 123. Wireless link 121 can be implemented by the Bluetooth standard, for example. In other related embodiments, data processor 107 is also connected to an Input/Output interface 109, which in turn drives a speaker 111 for audio output and receives audio input from a microphone 113. The described embodiments illustrate some of the non-limiting configurations for the active circuitry of augmented reality doll 101 according to embodiments of the invention.

Augmented reality glasses 123 can be any of commercially-available augmented reality glasses, such as Google Glass, or other proprietary augmented reality glasses.

In certain embodiments, data processing arrangement 103 stores executable code in non-transitory data and program storage 105, which executable code, when executed by data processor 107, implements features such as interactive game-playing capabilities; and artificial intelligence, including human language recognition and synthesis, as is known in the art. In related embodiments, the sophistication of the interactive game-playing capability is matched to the age and maturity of the user.

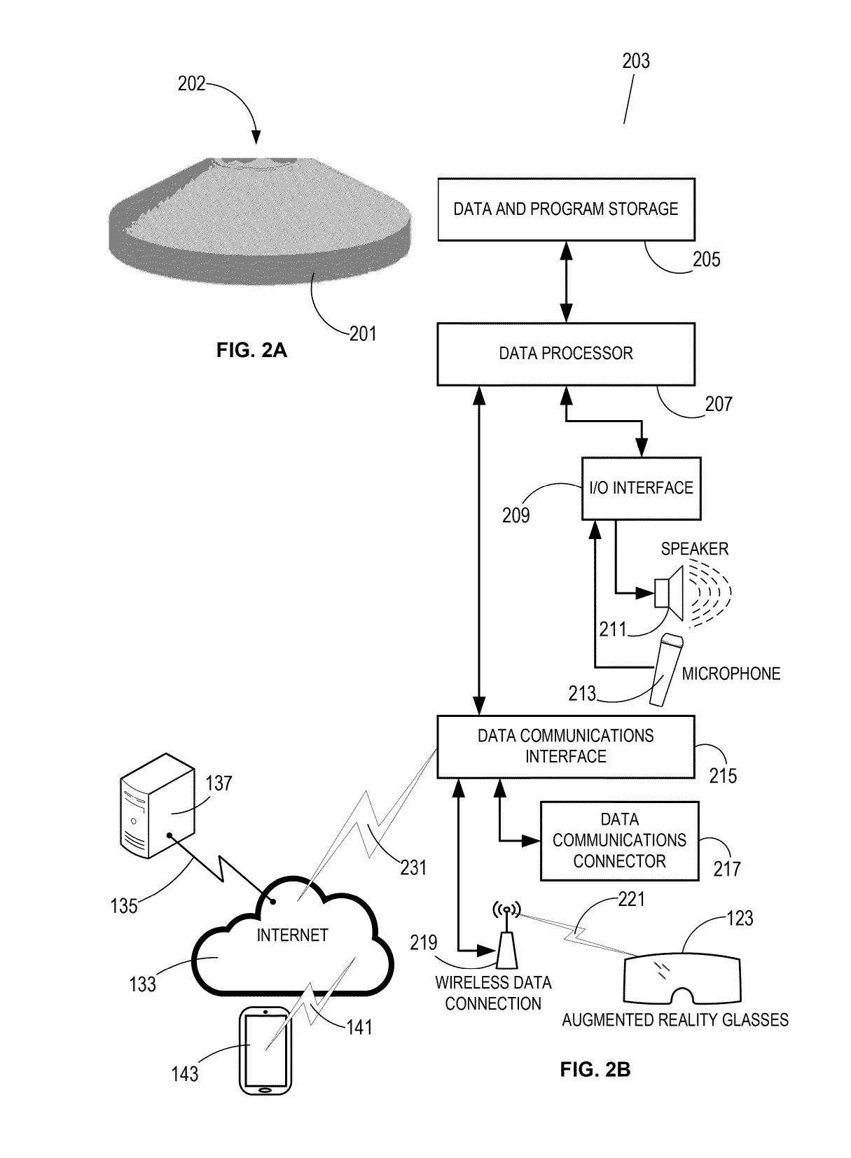

FIG. 2A illustrates a dock (or pedestal) 201 for physical augmented reality doll 101, according to an embodiment of the present invention. In certain embodiments, dock 201 has a data communications connector 202 for connection to data communications connector 115 of augmented reality doll 101 data processing arrangement 103 (FIG. 1B). In a related embodiment, augmented reality doll 101 and dock 201 establish a data connection between them. In an embodiment, the data connection is a wireless connection, such as by proximity radio frequency (RF) devices, Bluetooth devices, and the like.

FIG. 2B is a conceptual block diagram of a data processing arrangement 203 within dock 201 according to various embodiments of the present invention. A non-transitory data storage unit 205 stores data and program information for a data processor 207. A data communications interface 215 allows data processor 207 to communicate with augmented reality doll 101 connecting via data communications connector 117 to a data communications connector 217 (a non-limiting example of which is a USB connector). In a similar embodiment, data communications connector 117 also provides electrical power connections. In a related embodiment, a data connection 219 is a wireless data connection allowing communications with other devices via a wireless link 221, such as communications with augmented reality glasses 123. Wireless link 121 can be implemented by the Bluetooth standard, for example. In other related embodiments, data processor 207 is also connected to an Input/Output interface 209, which in turn drives a speaker 211 for audio output and receives audio input from a microphone 213. The described embodiments illustrate some of the non-limiting configurations for the active circuitry of dock 201 according to embodiments of the invention.

Particular embodiments of the invention provide that the desired data processing capabilities be distributed between data processing arrangement 103 and data processing arrangement 203. In certain other embodiments, audio input and audio output are distributed among data processing arrangement 103, data processing arrangement 203, and augmented reality glasses 123.

In certain embodiments, data processing arrangement 203 stores executable code in non-transitory data and program storage 205, which executable code, when executed by data processor 207, implements features such as interactive game-playing capabilities; and artificial intelligence, including human language recognition and synthesis, as is known in the art. In other embodiments, data processing arrangement 203 implements higher-level management facilities for augmented reality doll 101.

Supplementary to visual effects, certain embodiments of the present invention provide for audio input and output. In some embodiments, audio capabilities are provided at least in part by physical augmented reality doll 101 via speaker 111 and/or microphone 113. In other embodiments, audio capabilities are provided at least in part by dock 201 via speaker 211 and/or microphone 213. In still other embodiments, audio capabilities are provided at least in part by augmented reality glasses 123.

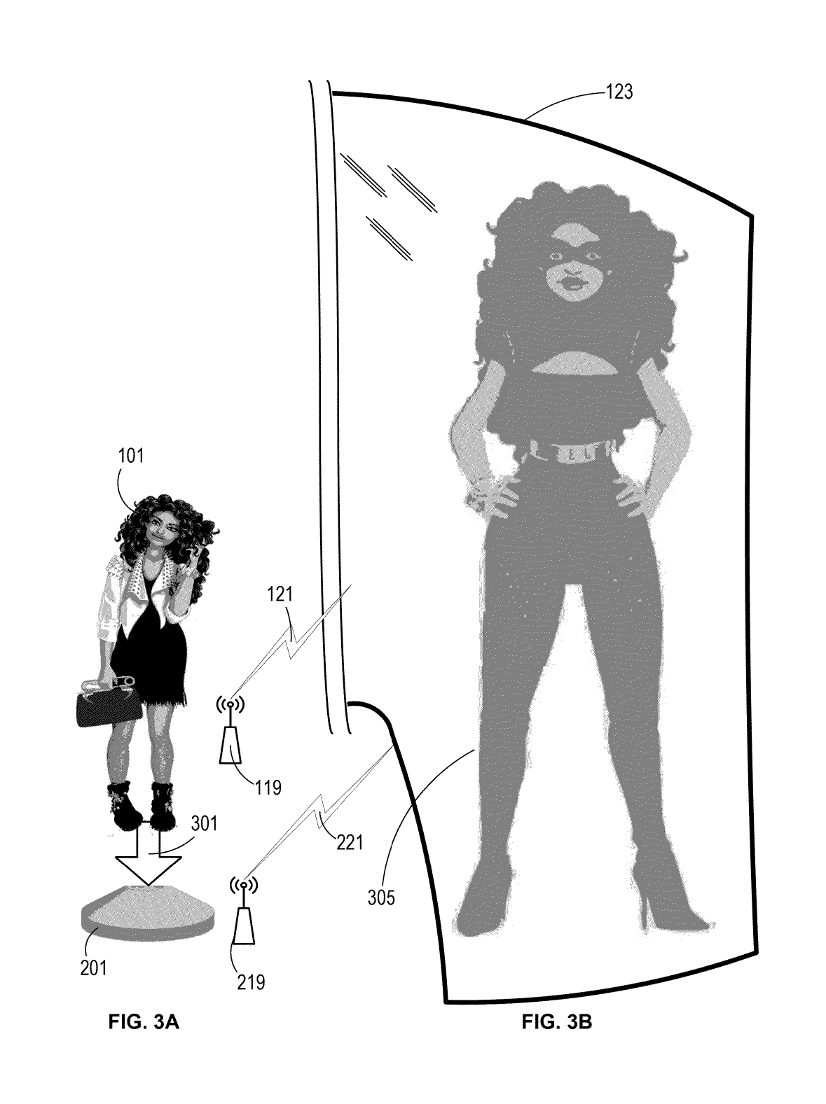

FIG. 3A illustrates a placing 301 of augmented reality doll 101 onto dock 201, such that data communications connector 117 of augmented reality doll 101 connects together with data communications connector 217 of dock 201. FIG. 3B illustrates a virtual version 305 of augmented reality doll 101 as seen using augmented reality glasses 123.

In an embodiment of the present invention, data for virtual version 305 is communicated for display on augmented reality glasses 123 via a wireless communication link 221 from data connection 219 of dock 201, which is initiated when augmented reality doll 101 is placed onto dock 201. In another embodiment of the present invention, data for virtual version 305 is communicated for display on augmented reality glasses 123 via a wireless communication link 121 from wireless data connection 119 of augmented reality doll 101, which is initiated when augmented reality doll 101 is placed onto dock 201. In still another embodiment of the present invention, data for virtual version 305 is communicated for display on augmented reality glasses 123 via a wireless communication link 121 from data connection 119 of augmented reality doll 101, which is initiated without having to place augmented reality doll 101 onto dock 201.

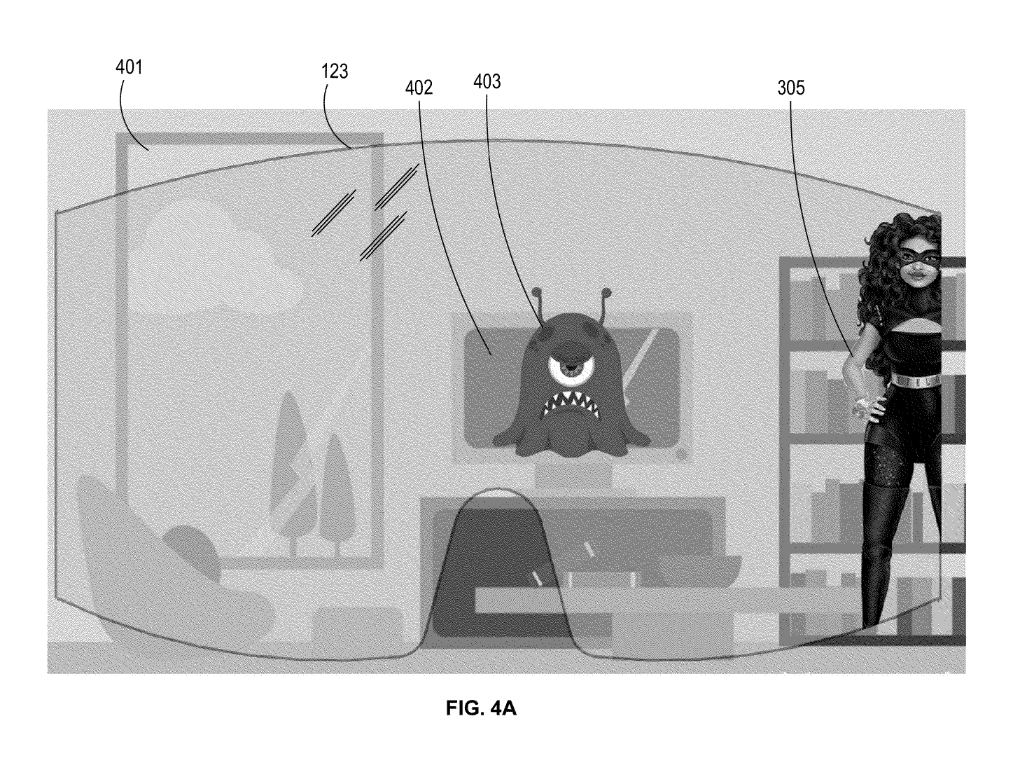

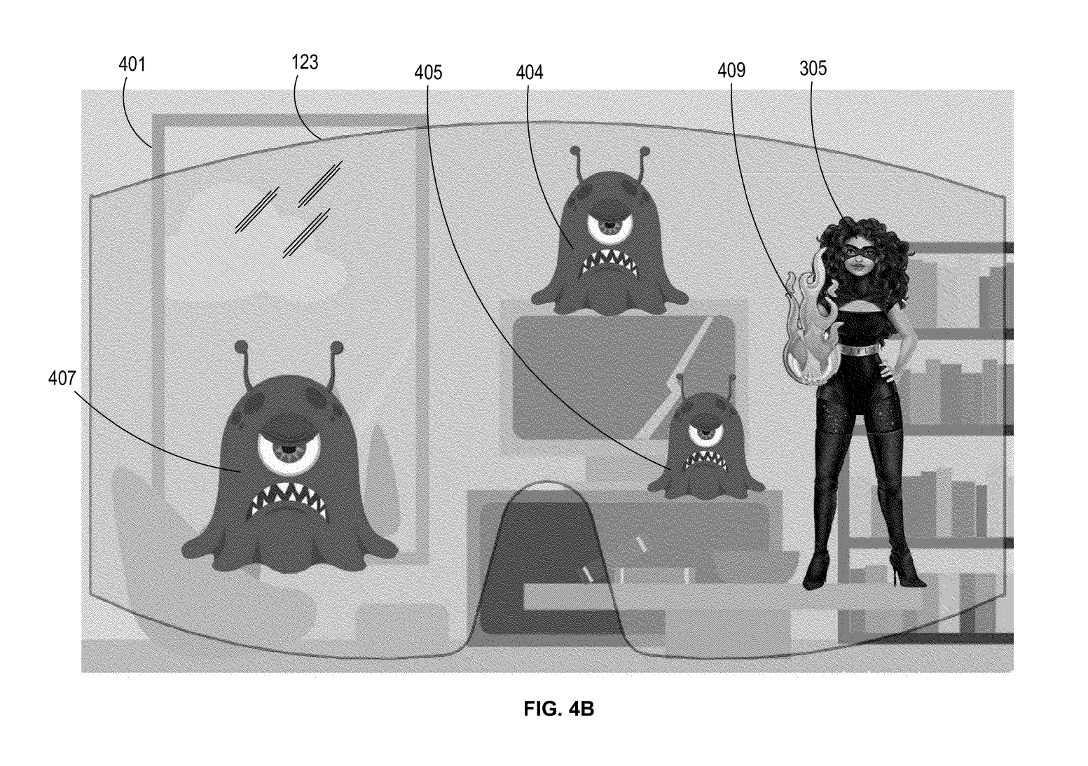

FIG. 4A illustrates a scene of a hypothetical video game being displayed on a television or computer screen 402, while at the same time featuring a view of a virtual version 305 of augmented reality doll 101 as seen with augmented reality glasses 123 according to an embodiment of the present invention. A physical environment 401 is visible through augmented reality glasses 123, and in FIG. 4A it is noted that only part of virtual version 305 is visible; portions of virtual version 305 outside of the boundaries of augmented reality glasses 123 are not seen in physical environment 401. A video game feature 403 is displayed on television or computer screen 402 and is not displayed by augmented reality glasses 123. In a related embodiment, video game feature 403 is provided by active electronics associated with augmented reality doll 101, and is sent to television or computer screen 402 for display. Because video game feature 403 is displayed by a device in physical environment 401, video game feature 403 is visible to anyone in physical environment 401, although virtual version 305 of augmented reality doll 101 is visible only to the person wearing augmented reality glasses 123.

In another embodiment of the present invention, the video game is displayed as an augmented feature of the surrounding environment, without the need for a television or computer screen. In this embodiment, the environment serves as the background medium for the video game, which is seen exclusively through augmented reality glasses 123 and is not visible to others in physical environment 401 who are not viewing through augmented reality glasses 123.

FIG. 4B illustrates a scene of a hypothetical video game in augmented reality, and featuring a view of virtual version 305 of augmented reality doll 101 according to another embodiment of the present invention. According to this embodiment, video game features 404, 405, 407, and 409 are displayed by augmented reality glasses 123, rather than by a display screen that is part of physical environment 401. According to this embodiment, in addition to virtual version 305, all video game features 404, 405, 407, and 409 are visible only to the person wearing augmented reality glasses 123. In this embodiment, video game feature 409 is manipulated by virtual version 305 of augmented reality doll 101, and thus virtual version 305 can participate in the interactive video game action, such as by assisting the user in playing the game and/or by joining with the user as a team. In addition, in this embodiment, no display screen is needed in the physical environment, and thus the video game can continue to be played as the wearer of augmented reality glasses 123 moves to a different physical environment.

### ADDITIONAL FEATURES

Further embodiments of the present invention provide additional features involving remote interaction between physical augmented reality doll 101 and remote data devices. FIG. 1B illustrates a wireless connection 131 between data communications interface 115 and Internet 133. In an embodiment of the present invention, a remote server 137 connected by a link 135 provides interactive voice-based information searching for processor 107.

In a non-limiting example, the user (such as a child) asks for the answer to a problem in arithmetic, the question is received via microphone 113 and is transmitted to processor 107 by I/O interface 109. Processor 107 then accesses remote server 137, and in combination therewith analyzes the audio signal to extract and answer the question, using automated speech recognition (ASR) and text-to-speech (TTS) technologies similar to those employed in smartphone voice interaction systems. The answer to the posed problem is then returned to the user via speaker 111.

According to another embodiment, a remote user device 143 (non-limiting examples of which include a smartphone and a portable tablet computer) is connected via a wireless link 141 to Internet 133 and thence to data communications interface 115 via link 131. Remote user device 143 can be employed by a parental user or a child user of appropriate age. The term “parental user” herein denotes any responsible adult providing guidance to a child user of a physical augmented reality doll according to embodiments of the present invention, including, but not limited to a biological parent or legal guardian of the child user.

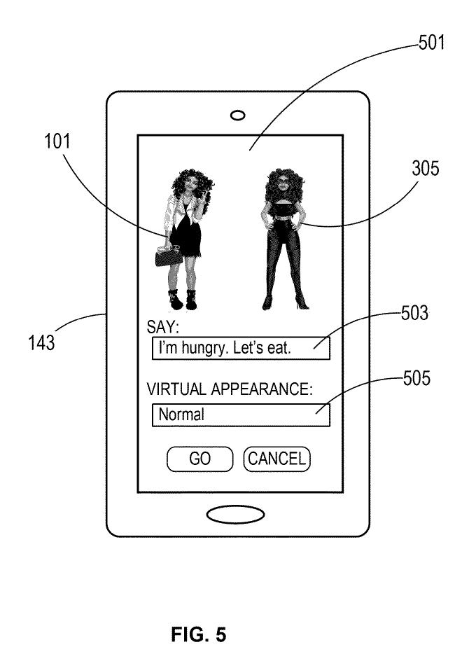

FIG. 5 illustrates a related embodiment, in which remote user device 143 has an application (“app”) 501 by which a user, such as a parental user, can input what they want physical augmented reality doll 101 to say to the child user. In a non-limiting example, a parental user believes it is time for the child user to eat a meal, and the parental user wants augmented reality doll 101 to encourage the child user to eat. The parental user inputs the suggestion phrase text “I'm hungry. Let's eat.” into a field 503 and then activates the app to carry out the order. According to this embodiment, physical augmented reality doll 101 then vocalizes the suggestion phrase text to the child user via TTS capabilities employed by data processor 107 either as a stand-alone TTS capability or via a TTS capability in combination with the remote server 137.

In another non-limiting example, the parental user believes it is time for the child user to sleep, and the parental user wants augmented reality doll 101 to encourage the child user to get ready for bed. In this example, the parental user inputs the suggestion phrase “I'm sleepy. Let's go to bed.” into field 503, and also selects a suitable virtual appearance in a field 505, such that virtual version 305 would be dressed in pajamas and bedroom slippers as shown to the parental user in app 501. When the parental user activates the app to carry out the order, physical augmented reality doll 101 then vocalizes the suggestion phrase to the child user, and modifies the appearance of virtual version 305 so that when the child user views through augmented reality glasses 123, virtual version 305 will be seen as wearing pajamas and bedroom slippers by the child user.

In a further non-limiting example, the child user is of an appropriate age and does not require parental user supervision in basic matters involving meals and bedtimes, and therefore instead of input by a parental user (as in the non-limiting examples above), the child user can input phrases to be vocalized, and appearances for virtual version 305 to adopt, via app 501 on remote user device 143.

Additional embodiments of the present invention provide adaptive learning capabilities for the augmented virtual reality doll, so that as the child user grows and develops, the augmented virtual reality doll grows and develops accordingly. For example, as the child user interacts with the augmented virtual reality doll, the doll learns responses and reactions that are meaningful to the child user.

What is claimed is:

1. An augmented reality doll comprising:
a physical doll;
an active electronic data device including a data processor;
a non-transitory data and program storage unit; containing executable code for execution by the data processor;
a data communications interface; and
a data connection for connecting to augmented reality glasses;
wherein the active electronic data device, via the executable code executed by the data processor, is operative to connect via the data connection to the augmented reality glasses and to communicate data to the augmented reality glasses for display of a virtual version of the augmented reality doll.

2. The augmented reality doll of claim 1, wherein the data connection is a wireless data connection.

3. The augmented reality doll of claim 1, wherein at least one of the active electronic data device, the data processor, the data and program storage unit, the data communications interface, or the data connection is contained within the physical doll.

4. The augmented reality doll of claim 1, wherein at least one of the active electronic data device, the data processor, the data and program storage unit, the data communications interface, or the data connection is contained within a dock separate from the physical doll, wherein the physical doll and the dock are operative to establish a data connection between themselves, such that when the data connection is established, data is communicated to the augmented reality glasses for display of the virtual version of the augmented reality doll.

5. The augmented reality doll of claim 1, wherein the executable code contains additional code related to a video game, such that when the additional code is executed by the data processor, the data processor causes features of the video game to be displayed by the augmented reality glasses.

6. The augmented reality doll of claim 1, wherein the physical doll is sized in weight and height according to a height and weight of a child using the augmented reality doll.

7. The augmented reality doll of claim 5, wherein the video game is matched to the age and maturity of a person using the augmented reality doll.

8. The augmented reality doll of claim 1, further comprising a wireless connection to the Internet.

9. The augmented reality doll of claim 8, wherein the active electronic data device is operative to communicate with a remote server on the Internet.

10. The augmented reality doll of claim 9, wherein a combination of the active electronic data device and the remote server is operative to perform automatic speech recognition (ASR) and text-to-speech (TTS).

11. The augmented reality doll of claim 8, wherein the active electronic data device is operative to communicate with an app on a remote user device.

12. The augmented reality doll of claim 11, wherein the active electronic data device is further operative to communicate with a remote server on the Internet.

13. The augmented reality doll of claim 11, wherein the active electronic data device is operative to perform text-to-speech (TTS) and is operative to receive text from the app and to cause the augmented reality doll to vocalize the text.

14. The augmented reality doll of claim 12, wherein the active electronic data device in combination with the remote server is operative to perform text-to-speech (TTS) and is operative to receive text from the app and to cause the augmented reality doll to vocalize the text.

15. The augmented reality doll of claim 11, wherein the active electronic data device is operative to modify the appearance of the virtual version of the augmented reality doll according to the app.
